(19) United States
(12) Patent Application Publication
(10) Pub. No.: US 2012/0279471 A1
(43) Pub. Date: Nov. 8, 2012

(54) SPARK IGNITION FOUR-STROKE CYCLE ENGINE

(76) Inventor: Yasuhito Yaoita, Oota-ku (JP)

(21) Appl. No.: 13/465,058

(22) Filed: May 7, 2012

(30) Foreign Application Priority Data
May 8, 2011 (JP) A2011-103914

(51) Int. Cl. F02B 75/02

(52) U.S. Cl. 123/315

(57) ABSTRACT

A second exhaust poppet valve 9 is provided in a portion of a combustion chamber expanded out of a main cylinder 1. A valve cover 7 reciprocates within a sub-cylinder 4 and covers a bottom surface of the second exhaust poppet valve 9. A first exhaust valve 10 and an intake poppet valve 11 are provided so as to face an upper surface of a piston 2. After the second exhaust poppet valve 9 is opened and hot high-pressure burned gas starts to flow away, the first exhaust poppet valve 10 is opened. As a result, the temperature of the first exhaust poppet valve 10 is reduced and the compression ratio can be increased. Then, a work amount of the piston is increased. The increased work amount compensates an amount of cooling loss due to increasing a surface area of the combustion chamber.

### BACKGROUND OF THE INVENTION

1. Field of the Invention

The present invention relates to compensating amount of cooling loss of a spark ignition four-stroke cycle engine whose combustion chamber is expanded out of a main cylinder.

2. Description of the Related Art

FIG. 5 shows an engine disclosed in FIG. 8 of Japanese Patent Application No. 2009-241923 (Japanese Patent No 4558090, hereinafter referred to as “Patent Document 1”). A combustion chamber of this engine is expanded out of its cylinder. A poppet valve and a sub-cylinder are provided in the expanded combustion chamber. A valve cover which covers a bottom surface of the poppet valve is inserted into the sub-cylinder. Therefore, in response to increasing a surface area of an inner wall of the combustion chamber expanded out of the cylinder, the heat dissipation area is increased and the cooling loss amount is increased.

Increasing the cooling loss amount results in deteriorating the fuel consumption.

In the configuration of Patent Document 1 in which an intake valve and an exhaust valve are provided to be aligned with an upper surface of a piston, there is no means for compensating the cooling loss amount due to increasing of the surface area of the inner wall of the combustion chamber expanded out of the cylinder.

An exhaust poppet valve of the conventional gasoline engine is made of heat-resisting steel. The conventional technique described in Japanese Patent Application No. H08-90339 (Japanese Patent Laid-Open No H09-256821, hereinafter referred to as “Patent Document 2”) discloses “although a valve comprising a mushroom-like valve body having a valve shaft and a valve head in series is generally used as an engine valve, an exhaust valve of the engine in particular is exposed to hot exhaust gas and the maximum temperature of a valve face portion of the valve head reaches 700 degree Celsius.”

In the course of a compression stroke, the temperature of the fuel-air mixture compressed by the piston becomes higher than the temperature of a coolant of the engine under operation. Then, the heat of the hot fuel-air mixture is discharged to the wall of the combustion chamber.

However, the fuel-air mixture portion in contact with the bottom surface of the exhaust valve is overheated to 700 degree Celsius at high load is heated during the compression stroke. Then, the temperature of the entire fuel-air mixture becomes higher and the knocking at high load will tend to occur.

Furthermore, the maximum temperature of the exhaust poppet valve of the conventional gasoline engine is higher than the temperature of the unburned fuel-air mixture in igniting at high load. Accordingly, at high load, the combustion rate for the hot fuel-air mixture in contact with the exhaust poppet valve becomes greater than that of other fuel-air mixture portion. Then, the pressure and temperature within the combustion chamber is dramatically increased during burning and the knocking at high load will tend to occur.

Because of the above description, the compression ratio of the conventional four-stroke cycle engine is limited to the value which does not cause the knocking.

In order to cause a three-way component catalyst to act properly, the oxygen should not be flown away to an exhaust pipe. For this purpose, in a four-stroke cycle engine with the three-way component catalyst, a valve opening time for the intake poppet valve is set to be approximately simultaneous with a valve closing time for the exhaust poppet valve.

The burned gas remains in the main combustion chamber at the exhaust top dead center. The intake gas which flows into the cylinder during the intake stroke is mixed with the burned gas which remains in the cylinder. Therefore, the spark ignition four-stroke cycle engine can provide the fuel-air mixture at the stoichiometric fuel-air ratio only when the fuel is supplied to not only the intake gas which flows into the cylinder, but also the burned gas which remains in the cylinder. As a result, in the above mentioned engine with the three-way component catalyst, as the amount of the burned gas remaining in the cylinder becomes larger, the fuel supply amount becomes larger, thereby limiting the fuel consumption improvement.

### SUMMARY OF THE INVENTION

The object of this invention is to provide means for compensating increasing an amount of cooling loss due to increasing a surface area of an inner wall of a combustion chamber expanded out of a main cylinder.

The detail configuration of the invention is described below.

A spark ignition four-stroke cycle engine has a cylinder head, a cylinder block, a main cylinder, a piston, a combustion chamber, an ignition plug, a sub-cylinder, a valve cover, an intake poppet valve, a first exhaust poppet valve and a second exhaust poppet valve.

The piston reciprocates within the main cylinder. The combustion chamber is expanded out of the main cylinder. The sub-cylinder is provided external to the main cylinder.

The second exhaust poppet valve is provided on a wall surface of the combustion chamber expanded out of the main cylinder.

The first exhaust poppet valve and the intake poppet valve are provided on other wall surface of the combustion chamber which faces an upper surface of the piston.

The valve cover reciprocates within the sub-cylinder. The valve cover covers a bottom surface of a head portion of the second exhaust poppet valve. A piston ring is provided between the valve cover and the sub-cylinder.

A cylindrical outer peripheral surface of the valve cover has two semi-peripheral surfaces. A path is formed for communicating between one of the semi-peripheral surfaces which is closer to a central axis of the main cylinder and a space within the main cylinder.

Patent Document 1 discloses the configuration described above.

In addition, the engine according to the present invention has the unique configuration as follows.

The second exhaust poppet valve whose bottom surface of the head portion is covered by the valve cover is opened at first.

Then, the first exhaust poppet valve with no valve cover is opened after opening the second exhaust poppet valve, and the first exhaust poppet valve is opened before reaching a bottom dead center of an exhaust stroke.

The action and advantage of this invention are described below.

At first, the second exhaust poppet valve is opened. It should be noted that a valve opening time of the second exhaust poppet valve is approximately similar to a valve opening time of the exhaust poppet valve of a gasoline engine without a valve cover.

Then, a hot high pressure burned gas is flown out through the second exhaust poppet valve. A temperature and a pressure of the burned gas within the cylinder are then reduced. After that, the first exhaust poppet valve is opened before reaching a bottom dead center of an exhaust stroke.

Then, the temperature of the burned gas flown out through the first exhaust poppet valve becomes lower than that of the burned gas flown out through the second exhaust poppet valve. Thus, the temperature of the first exhaust poppet valve becomes lower than the exhaust poppet valve of the conventional engine which with no valve covers.

Accordingly, the temperature of the fuel-air mixture portion in contact with the first exhaust poppet valve at the high load ignition becomes lower than the temperature of the fuel-air mixture portion in contact with the exhaust poppet valve without no valve cover.

It should be noted that the bottom surface of the head portion of the second exhaust poppet valve is covered with the valve cover and not in contact with the burned gas. Therefore, the temperature of the bottom surface of the second exhaust poppet valve does not become higher. In addition, few fuel-air mixtures are in contact with the bottom surface of the second exhaust poppet valve.

Accordingly, in the engine according to this invention, the increasing of the temperature of the fuel-air mixture portion in contact with the first exhaust poppet valve is limited and the increasing of the temperature of the entire fuel-air mixture is limited. Therefore, comparing to the conventional engine with no valve cover, the resistance for knocking of the engine according to this invention is improved. Furthermore, in the engine according to this invention, the increasing of the flame propagation speed for the fuel-air mixture portion in contact with the first exhaust poppet valve is limited.

Accordingly, the engine according to this invention can increase the compression ratio in response to the reduced temperature of the first exhaust poppet valve. Increasing the compression ratio causes an amount of work of the piston to increase. The increased amount of work of the piston compensates the increased amount of heat loss due to the increased surface area of the inner surface of the combustion chamber expanded out of the main cylinder.

In this manner, the above mentioned object can be achieved.

The improved resistance for knocking can increase the compression ratio of the engine according to this invention. Therefore, in the engine according to this invention with the increased compression ratio, the amount of the burned gas remaining within the main combustion chamber at the exhaust top dead center is reduced. As described in the Description of the Background Art, as the amount of the burned gas remaining in the cylinder becomes larger, the fuel supply amount becomes larger, thereby deteriorating the fuel consumption. As a result, in the engine according to this invention with the increased compression ratio, the volume of the combustion chamber and the amount of burned gas at the exhaust top dead center is reduced and the fuel consumption is improved comparing to the engine with the configuration described in Patent Document 1 in which the intake valve and the exhaust valve are provided so as to align with the upper surface of the piston.

In contrast to the action and advantage of this invention as described above, there is a following disadvantage in the conventional art.

In the engine without the valve cover which is provided in contact with the bottom surface of the head portion of the exhaust valve, the both faces of the head portion of the exhaust poppet valve is heated by the hot exhaust gas flown out at starting the exhaust stroke. The fuel-air mixture portion in contact with the bottom surface of the head portion of the exhaust poppet valve is then heated and the knocking will tend to occur. As a result, the compression ratio cannot be improved in the engine with no valve cover.

All configurations described in Patent Document 1 have their valve covers. In the configuration described in Patent Document 1, all poppet valves provided to be aligned with the upper surface of the piston are intake valves and no exhaust poppet valve is provided so as to align with the upper surface of the piston. Therefore, the resistance for knocking is improved.

In the present invention, a second exhaust poppet valve starts to exhaust at first and a valve cover covers a bottom surface of a head portion of the second exhaust poppet valve. There is no description in Patent Document 1 that, in case that an exhaust valve with the valve cover and another exhaust valve without the valve cover are provided, the valve cover covers the bottom surface of the head portion of the exhaust valve which starts to exhaust at first. Therefore, in the configuration described in Patent Document 1, the intake poppet valve and the exhaust poppet valve are provided so as to align with the upper surface of the piston and the unique configuration of the present invention as described above is not involved. Thus, in the configuration in Patent Document 1, the temperature of the exhaust poppet valve provided so as to align with the upper surface of the piston is higher, the resistance for knocking cannot be improved and the object of the present invention cannot be achieved. The unique configuration of the present invention as described above will be described around the last portion of the configuration of the present invention.

### BRIEF DESCRIPTION OF THE DRAWINGS

FIG. 1 illustrates an engine at a top dead center in a compression stroke of a first embodiment;

FIG. 2 illustrates the engine at the crank angle of 40 degree before a bottom dead center in an exhaust stroke according to the first embodiment;

FIG. 3 illustrates the engine at the crank angle of 25 degree before the bottom dead center in the exhaust stroke according to the first embodiment;

FIG. 4 illustrates the engine at a top dead center of an exhaust stroke according to a third embodiment; and

FIG. 5 shows an engine disclosed FIG. 8 of Patent Document 1.

### DETAILED DESCRIPTION OF THE PREFERRED EMBODIMENTS

A first embodiment is now described below.

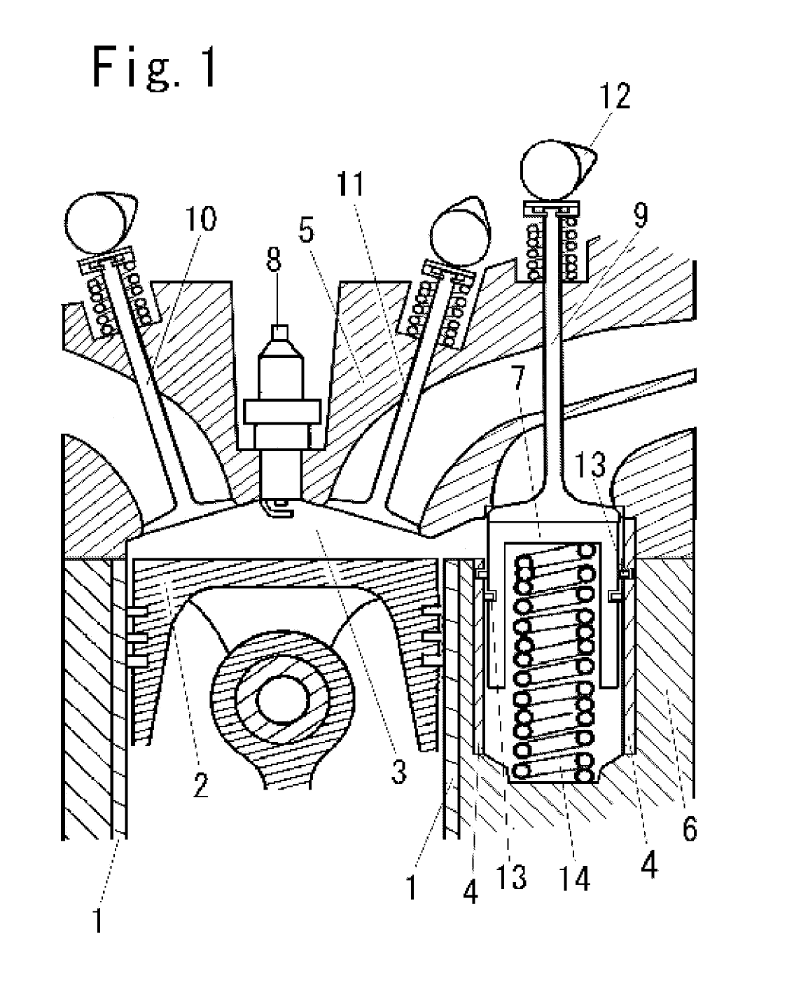

A spark ignition four-stroke cycle engine illustrated in FIGS. 1 to 4 comprises a cylinder head 5, a cylinder block 6, a main cylinder 1, a piston 2, a combustion chamber 3, an ignition plug 8, a sub-cylinder 4, a valve cover 7, an intake poppet valve 11, a first exhaust poppet valve 10 and a second exhaust poppet valve 9.

The piston 2 has a groove for a piston ring and reciprocates within the main cylinder 1. The combustion chamber 3 is formed between the cylinder head 5 and the piston 2. Further, the combustion chamber 3 is expanded out of the main cylinder 1.

The exhaust popper valve 9 is provided on a wall surface of the combustion chamber 3 expanded out of the main cylinder 1. One or more second exhaust poppet valves 9 may be provided.

The valve cover 7 has a cylindrical outer peripheral surface. The valve cover 7 reciprocates within the sub-cylinder 4. In order to bring an upper surface of the valve cover 7 in tightly contact with a bottom surface of a head portion of the poppet valve 9, a spring 14 is provided so as to align with a rear surface of the valve cover 7. The valve cover 7 and the second exhaust popper valve 9 are driven integrally by a cam 12 which drives the second exhaust poppet valve 9.

The valve cover 7 covers a bottom surface of the head portion of the second exhaust poppet valve 9. One or more piston rings 13 are provided between the valve cover 7 and the sub-cylinder 4. A ring groove for the piston ring 13 may be provided on a cylindrical outer peripheral surface of the valve cover 7 or an inner wall of the sub-cylinder 4.

The cylindrical outer peripheral surface of the valve cover 7 has a semi-peripheral surface closer to a central axis of the main cylinder 1 and another semi-peripheral surface far from the central axis of the main cylinder 1. The semi-peripheral surface closer to the central axis of the main cylinder is in communication with a space within the main cylinder 1 via a path 16.

The first exhaust poppet valve 10 and the intake poppet valve 11 are provided on other wall surface portion of the combustion chamber 7, the other wall surface facing the upper surface of the piston 2.

When the semi-peripheral surface closer to the central axis of the main cylinder 1 is set on the back surface of the combustion chamber 3 expanded out of the main cylinder 1, the compression ratio in the combustion chamber 3 can be increased.

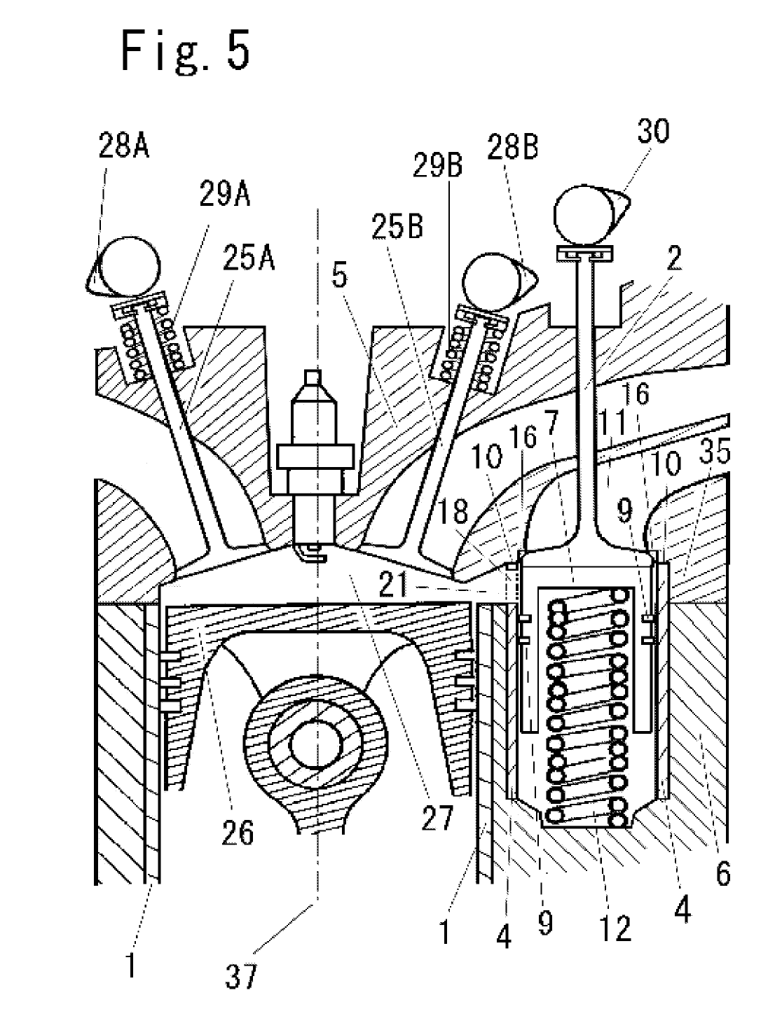

The above description is nearly same as that of Patent Document 1. The configuration in FIG. 5 which shows the conventional example is substantially same as the configuration in FIG. 1 of the present application.

The piston ring 13 provided between the cylindrical outer peripheral surface 7 of the valve cover 7 and the sub-cylinder 4 is the piston ring for the valve cover 7, and comprises an oil ring and a compression ring for sealing the burned gas within the combustion chamber 3.

It should be noted that the setting described above can increase the compression ratio within the combustion chamber 3 and may prevent the wall surface area from increasing. Increasing the wall surface area causes the cooling loss within the combustion chamber 3 to increase. In the setting which may increase the compression ratio within the combustion chamber 3, the space in contact with the semi-peripheral surface far from the central axis of the main cylinder 1 is formed only with a quench zone and is the narrow inflammable space. Therefore, the semi-peripheral surface far from the central axis of the main cylinder 1 and the wall surface in contact with it have the small amount of cooling loss.

Furthermore, the semi-peripheral surface closer to the central axis of the main cylinder 1 does not increase the wall surface area of the combustion chamber 3. Expanding the combustion chamber 3 out of the main cylinder 1 causes the wall surface area of the communication path 16 to increase rather than the surface area of the semi-peripheral surface closer to the central axis of the main cylinder 1.

The communication path 16 communicates between the semi-peripheral surface closer to the central axis of the main cylinder 1 and an interior space of the main cylinder 1.

Reducing the distance between the main cylinder 1 and the sub-cylinder 4 can limit increasing the wall surface area of the communication path 16.

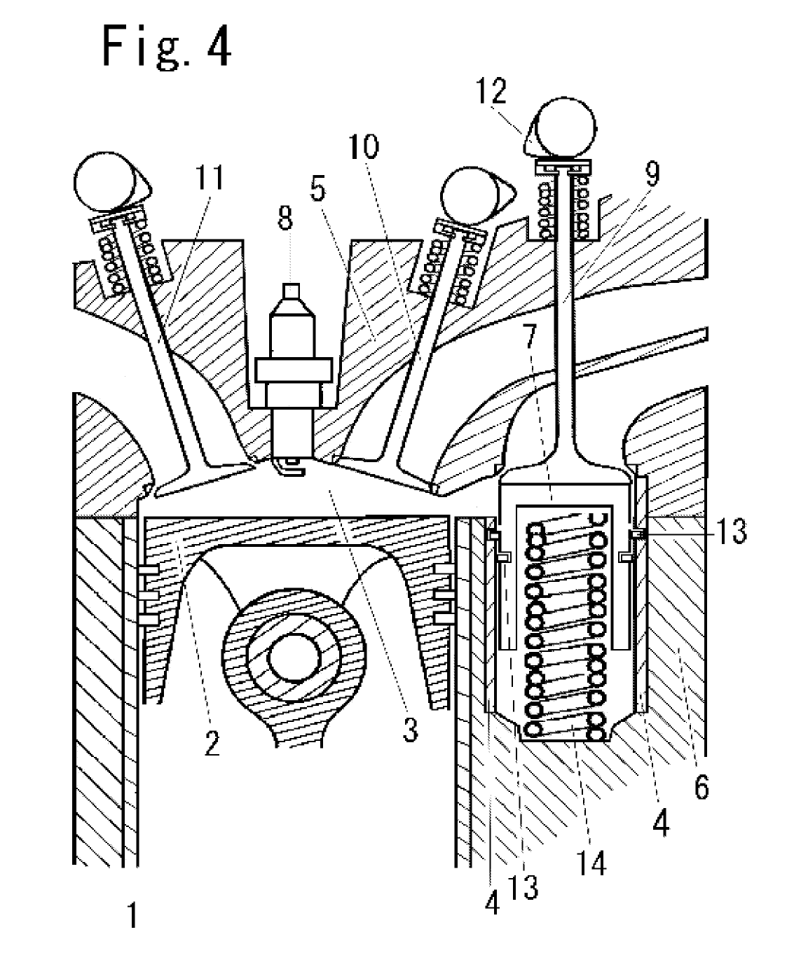

In the engine according to the first embodiment, the positional relationship between the first exhaust poppet valve 10 and the intake poppet valve 11 is not limited. In the engine illustrated in FIGS. 1 to 3, the intake poppet valve 11 is provided between the first exhaust poppet valve 10 and the second exhaust poppet valve 9. In addition, in the first embodiment, the intake poppet valve 11, the second exhaust poppet valve 9 and the first exhaust poppet valve 10 as shown in FIG. 4 may be provided. In FIG. 4, the first exhaust poppet valve 10 is provided between the intake poppet valve 11 and the second exhaust poppet valve 9.

The unique configuration of the present invention is now described below.

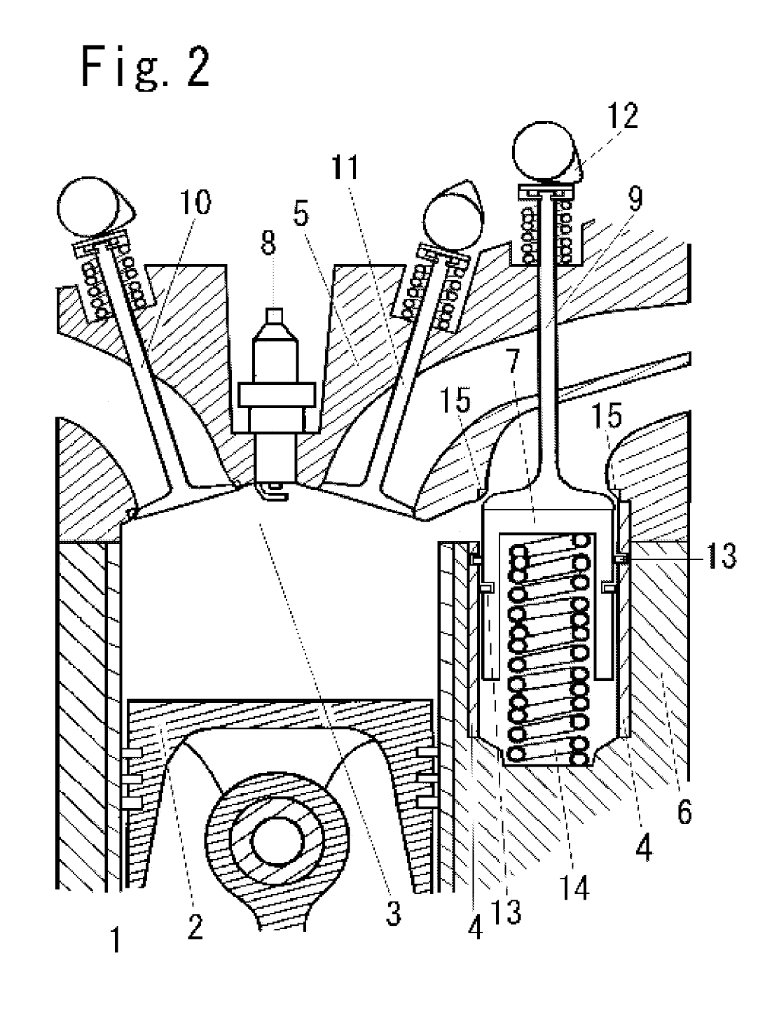

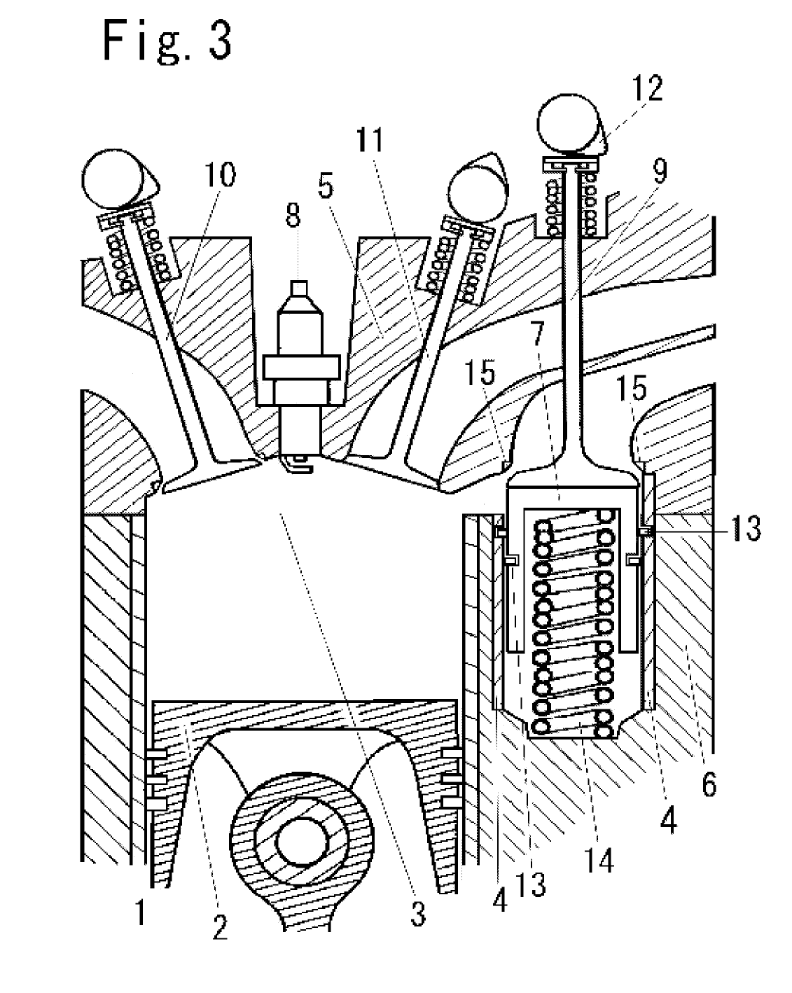

FIGS. 2 and 3 illustrate the unique configuration of the present.

The second exhaust poppet valve is opened at first.

In addition, in the engine according to the first embodiment, the first exhaust poppet valve 10 without the valve cover 7 is opened after opening the second exhaust poppet valve 9 before reaching the bottom dead center of the exhaust stroke. The upper surface of the valve cover 7 covers the bottom surface of the head portion of the second exhaust poppet valve 9.

An example of a valve opening time of the second exhaust poppet valve 9 and the first exhaust poppet valve 10 is described below.

The second exhaust poppet valve 9 is opened at a crank angle of 50 degree before reaching the bottom dead center of the exhaust stroke. At this point of time, the first exhaust poppet valve 10 is closed. In FIG. 2, the crank angle of 40 degree before reaching the bottom dead center is illustrated. Referring to FIG. 2, the second exhaust poppet valve 9 has just opened and is slightly open. Accordingly, the burned gas within the main cylinder begins to pass between the second exhaust poppet valve 9 and a valve seat 15 into an exhaust pipe.

The first exhaust poppet valve 10 is opened at the crank angle of 35 degree before the bottom dead center of the exhaust stroke. FIG. 3 illustrates the crank angle of 25 degree before reaching the bottom dead center of the exhaust center. Referring to FIG. 3, the first exhaust poppet valve 10 has just opened and is slightly open. In addition, the second exhaust poppet valve 9 shown in FIG. 3 is widely open more than the second exhaust poppet valve 9 shown in FIG. 2.

Accordingly, the temperature and pressure of the burned gas within the main cylinder at the crank angle of 35 degree before reaching the bottom dead center of the exhaust stroke is less than the temperature and pressure of the burned gas within the main cylinder in opening the second exhaust poppet valve 9.

The example of the valve opening time for two valves, i.e. the second exhaust poppet valve 9 and the first exhaust poppet valve 10 is not limited to the example described above. The valve opening time for the second exhaust poppet valve 9 and the first exhaust poppet valve 10 may be set to be at any crank angle other than the illustrated crank angles.

However, if a period of time from opening the second exhaust poppet valve 9 to opening the first exhaust poppet valve 10 is less than that of the described example, the effect of reducing the temperature of the first exhaust poppet valve 10 is deteriorated.

A second embodiment is now described below.

Hereinafter, only the difference between the first embodiment and the second embodiment is described.

Another example of the valve opening time for the second exhaust poppet valve 9 and the first exhaust poppet valve 10 is described.

In order to further reduce the temperature of the bottom surface of the first exhaust poppet valve 10, the first exhaust poppet valve 10 is preferably opened at a crank angle larger than that for the second exhaust poppet valve 9. If the valve opening time for the first exhaust poppet valve 10 is set in this manner, the gas pressure within the main cylinder may be too high after reaching the bottom dead center. In this manner, after reaching the bottom dead center of the exhaust stroke, an amount of exhaust loss work is increased.

In fact, it is required to seek the optimal valve opening time for the first exhaust poppet 10, which prevents the amount of exhaust loss work from increasing while increases the compression ratio.

As described in the “Description of the Background Art,” as the amount of the burned gas remaining in the main cylinder becomes larger, the fuel supply amount becomes larger, thereby the fuel consumption deteriorates.

In the four-stroke cycle engine with no valve cover, the exhaust poppet valve is positioned adjacent to the intake poppet valve. Thus, when the valve closing time for the exhaust poppet valve is set to be after opening the intake poppet valve, an intake gas flowing into the main cylinder at high speed rotation can scavenge the burned gas remaining in the main cylinder, but the intake gas is flown away to the exhaust pipe.

In order to cause a three-way component catalyst act properly, the oxygen should not be flown away to the exhaust pipe. For this purpose, in the spark ignition four-stroke cycle engine with the three-way component catalyst, the valve opening time for the intake poppet valve is set to be approximately simultaneous with the valve closing time for the exhaust poppet valve.

As a result, the spark ignition four-stroke cycle engine with the three-way component catalyst is not able to scavenge effectively at the exhaust top dead center.

The above problem can be solved by a third embodiment described below referring to FIG. 4.

In the third embodiment, the following configurations are added to the first and second embodiments.

In the third embodiment, the positional relationship between the first exhaust poppet valve 10 and the intake poppet valve 11 is limited. In other words, the first exhaust poppet valve 10 is provided between the intake poppet valve 11 and the second exhaust poppet valve 9. The intake poppet valve 11 is not adjacent to the second exhaust poppet valve 9.

The end of the valve opening period for the second exhaust poppet valve 9 overlaps with the start of the valve opening period for the intake poppet valve 11. The period during which the second exhaust poppet valve 9 and the intake poppet valve 11 overlaps with each other is around the top dead center of the exhaust stroke. In FIG. 4, the top dead center of the exhaust stroke is illustrated.

The valve closing time for the second exhaust poppet valve 9 is set to be later than that of the first exhaust poppet valve 10. The first exhaust poppet valve 10 is closed approximately simultaneously with the valve opening time of the intake poppet valve 11 is opened. In other words, immediately after the intake poppet valve 11 is opened, the first exhaust poppet valve 10 is closed. When the intake poppet valve 11 is opened, the first exhaust poppet valve 10 is closed.

Hereinafter the action and effects of the third embodiment are described.

When the intake poppet valve 11 is opened at the high speed rotation, the intake gas flowing into the combustion chamber 3 more vigorously is flown in contact with the bottom surface of the first exhaust poppet valve 10 and the flown intake gas causes the burned gas within the combustion chamber to move toward the second exhaust poppet valve 9. At this point of time, the first exhaust poppet valve 10 is closed while the second exhaust poppet valve is not closed. Therefore, the burned gas is flown away via the second exhaust poppet valve 9 and is not flown away via the first exhaust poppet valve 9. In addition, the valve closing time for the second exhaust poppet valve 9 and the valve opening time for the intake poppet valve 11 are set so as not to flow the intake gas away via the second exhaust poppet valve 9.

Thus, according to the configuration of the third embodiment, the burned gas can be scavenged without flowing the intake gas via the first exhaust poppet valve 10. This results in reducing the amount of the burned gas remaining within the main cylinder at an intake stroke, thereby reducing the fuel supply amount and improving the fuel consumption comparing than the first and second embodiments.

In addition, the oxygen is not flown away into the exhaust pipe. Thus, the three-way component catalyst acts properly.

The engine according to the first and second embodiments have an element to improve the fuel consumption by improving the compression ratio and an element to deteriorate the fuel consumption due to increasing a surface area of the inner wall of the combustion chamber. On the other hand, for the engine according to the third embodiment, an element to improve the fuel consumption by scavenging is added to the two inconsistent elements described above.

The space in contact with the semi-peripheral surface far from the central axis of the main cylinder 1 is a portion of the cylindrical outer peripheral surface of the valve cover 7 and is the narrow space formed only by an anti-inflammatory layer. Furthermore, the wall surface area of the communication path 16 between the semi-peripheral surface of the valve cover 7 closer to the central axis of the main cylinder 1 and the space within the main cylinder 1 is enough limited, the amount of cooling loss within the combustion chamber is reduced and the fuel consumption of the engine according to the third embodiment is improved comparing than the gasoline engine whose combustion chamber is not expanded out of the main cylinder.

Also, adding a device to vary the valve closing time for the second exhaust poppet valve and the valve opening time for the intake poppet valve can realize the optimal scavenging.

Now, a fourth embodiment is described.

At low load, the temperature of the exhaust poppet valve is not required to reduce. Accordingly, in the first to third embodiment, a device for stopping to drive the valves is provided between the cam 12 to drive the second exhaust poppet valve and an upper end of a stem of the second exhaust poppet valve. In this manner, the second exhaust poppet valve may be stopped at low load. Thus, the negative amount of work to drive the second exhaust poppet valve is not generated.

What is claimed is:

1. A spark ignition four-stroke cycle engine having a cylinder head, a cylinder block, a main cylinder, a piston which reciprocates within the main cylinder, a combustion chamber, an ignition plug, a sub-cylinder, a valve cover, an intake poppet valve, a first exhaust poppet valve and a second exhaust poppet valve, the combustion chamber being expanded out of the main cylinder, the sub-cylinder being provided external to the main cylinder, the second exhaust poppet valve being provided on a wall surface of the combustion chamber expanded out of the main cylinder, the first exhaust poppet valve and the intake poppet valve being provided on other wall surface of the combustion chamber which faces an upper surface of the piston, the valve cover reciprocating within the sub-cylinder, the valve cover covering a bottom surface of a head portion of the second exhaust poppet valve, a piston ring being provided between the valve cover and the sub-cylinder, and a cylindrical outer peripheral surface of the valve cover having two semi-peripheral surfaces, and a path being formed for communicating between one of the semi-peripheral surfaces which is closer to a central axis of the main cylinder and a space within the main cylinder, characterized in that
the second exhaust poppet valve whose bottom surface of the head portion is covered by the valve cover is opened at first,
the first exhaust poppet valve with no valve cover is opened after opening the second exhaust poppet valve, and
the first exhaust poppet valve is opened before reaching a bottom dead center of an exhaust stroke.

2. A spark ignition four-stroke cycle engine having a cylinder head, a cylinder block, a main cylinder, a piston which reciprocates within the main cylinder, a combustion chamber, an ignition plug, a sub-cylinder, a valve cover, an intake poppet valve, a first exhaust poppet valve and a second exhaust poppet valve, the combustion chamber being expanded out of the main cylinder, the sub-cylinder being provided external to the main cylinder, the second exhaust poppet valve being provided on a wall surface of the combustion chamber expanded out of the main cylinder, the first exhaust poppet valve and the intake poppet valve being provided on other wall surface of the combustion chamber which faces an upper surface of the piston, the valve cover reciprocating within the sub-cylinder, the valve cover covering a bottom surface of a head portion of the second exhaust poppet valve, a piston ring being provided between the valve cover and the sub-cylinder, and a cylindrical outer peripheral surface of the valve cover having two semi-peripheral surfaces, and a path being formed for communicating between one of the semi-peripheral surfaces which is closer to a central axis of the main cylinder and a space within the main cylinder, characterized in that
the second exhaust poppet valve whose bottom surface of the head portion is covered by the valve cover is opened at first,
the first exhaust poppet valve with no valve cover is opened after opening the second exhaust poppet valve,
the first exhaust poppet valve is opened before reaching a bottom dead center of an exhaust stroke,
the first exhaust poppet valve is provided between the intake poppet valve and the second exhaust poppet valve,
an end of a valve opening period for the second exhaust poppet valve overlaps with a start of a valve opening period for the intake poppet valve around a top dead center of the exhaust stroke,
a valve closing time of the second exhaust poppet valve is set to be later than a valve closing time for the first exhaust poppet valve,
the first exhaust poppet valve is closed approximately simultaneously with a valve opening time for the intake poppet valve, and
a three-way component catalyst is provided.
